(19) United States
(12) Patent Application Publication
(10) Pub. No.: US 2006/0160556 A1
(43) Pub. Date: Jul. 20, 2006

(54) Adjusting measurement reports

(75) Inventors: Andreas Mueller, Waiblingen (DE); Tao Chen, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/314,536

(22) Filed: Dec. 22, 2005

Related U.S. Application Data
(60) Provisional application No. 60/643,761, filed on Jan. 14, 2005.

(51) Int. Cl. H04B 17/00; H04B 7/00

(52) U.S. Cl. 455/522; 455/67.11

(57) ABSTRACT

A method for selecting a communication parameter to be used in a communication system based on inputs including an estimate of communication quality between a first node and a second node, the method comprising selecting the parameter based on the estimate of communication quality and also the age of the estimate of communication quality.

This invention relates to adjusting measurement reports in communication systems. It is especially applicable to the frequency division duplex (FDD) high speed downlink packet access (HSDPA) link adaptation mechanism in HSDPA Node-Bs. This mechanism is generally based on channel quality feedback information received from the corresponding terminals.

In HSDPA, the link adaptation entity in the Node-B tries to adapt to the current channel conditions of a certain terminal by selecting the highest possible modulation and coding scheme keeping the frame error probability below a certain threshold. For that purpose, the terminals periodically send some channel quality feedback reports to the respective serving Node-B, which indicate the recommended transmission format for the next transmission time interval (TTI), including the recommended transport block size, the recommended number of codes and the supported modulation scheme as well as a possible power offset. The reported channel quality indicator (CQI) value is determined on the basis of measurements of the common pilot channel. In a typical implementation it is essentially a pointer to an index in one of the tables specified in the document “3GPP TS 25.214—Physical Layer Procedures (FDD)” that define the possible transmission format combinations (as mentioned above) for different categories of user equipment (UE).

As there is a certain delay between the measurement of the channel quality and the actual data transmission, the current channel quality at the instant when transmission is scheduled might significantly deviate from the channel quality reported by the terminal, leading to some bias of the channel estimation. Therefore, it is normal to additionally apply an outer loop link adaptation mechanism, which is based on the ACKs and NACKs from past transmissions. This outer loop link adaptation mechanism subtracts a continuously adjusted offset from the received CQI indices, resulting in the selection of generally stronger modulation and coding schemes than actually requested by the corresponding terminal, so that the residual block error rate after a certain number of transmission attempts does not exceed a certain value, which is normally chosen to be 1%. This technique is discussed in more detail in “A Method for Outer Loop Rate Control in High Data Rate Wireless Networks”, David W. Paranchych and Mehmet Yavuz, Proceedings of the 56^{th} IEEE Vehicular Technology Conference, Vol. 3, September 2002, pp. 1701-1705 and “Adaptive Control of Link Adaptation for High Speed Downlink Packet Access (HSDPA) in W-CDMA”, Michiharu Nakamura, Yassin Awad and Sunil Vadgama, Proceedings of the 5^{th} International Symposium on Wireless Personal Multimedia Communications (WPMC), October 2002, pp. 382-386.

Another key principle of HSDPA is fast scheduling in the Node-Bs. A commonly used scheduler is the so-called proportional fair (P-FR) scheduler. The basic idea of the P-FR scheduler is to exploit multi-user diversity by scheduling users only when they observe rather good channel conditions (“on top of their fades”), thus yielding a good compromise between maximizing the system capacity and achieving fairness among different users. Generally, the actual scheduling decision is based on certain scheduling metrics, which are re-calculated before every scheduling instant, and normally result simply in the user with the highest metric being served. For the P-FR scheduler, this metric is usually the ratio between the data rate that is considered to be achievable for a particular user in the next TTI and the average long-term throughput of that user.

It can be calculated as follows:

$${M}_{k} [ n ] = \frac{{R}_{k} [ n ]}{{T}_{k} [ n ]} = \frac{{R}_{ k} [ n ]}{\begin{matrix}( 1 - \{ \{ {B}_{ k} [ n ] > 0 \} ⋁ \{ {R}_{ k} [ n - 1 ] > 0 \} \} \cdot \\ {FF}_{ k} ) \cdot {T}_{ k} [ n - 1 ] + {FF}_{ k} \cdot {R}_{ k} [ n - 1 ]\end{matrix}}$$

Here, Mₖ[n] denotes the scheduling metric for user k at the time n, Rₖ[n] is the data rate that is assumed to be achievable in the next TTI and Tₖ[n] is the average long-term throughput of that user. The time period, over which the average user throughput is calculated, is influenced by the so-called Forgetting Factor (FFₖ). The forgetting factor is usually a constant value and identical for all users served by the same Node B. The average user throughput is only updated if the respective user has some data to transmit, i.e. if the number of bits waiting for transmission in the buffer of that user is larger than zero (Bₖ[n]>0), or if there was a data transmission in the last TTI (what corresponds to the logical expression Rₖ[n−1]>0). More information about proportional fair scheduling in general can be found in: “Charging and Rate Control for Elastic Traffic”, F. Kelly, European Transactions on Telecommunications, vol. 8, pp. 33-37, 1997, “Data Throughput of CDMA-HDR a High Efficiency-High Data Rate Personal Communication Wirless System”, A. Jalali, R. Padovani and R. Pankaj, Proceedings of the Vehicular Technology Conference (VTC), vol. 3, Tokyo, Japan, May 2000, pp. 1854-1858 and “Link and System Performance Aspects of Proportional Fair Scheduling in WCDMA/HSDPA”, T. E. Kolding, Proceedings of the 58^{th} Vehicular Technology Conference (VTC), vol. 3, Orlando (Fla.), USA, October 2003, pp. 1717-1722.

Usually, the terminals do not report the current channel quality to the serving Node B in every TTI, which might lead to situations where an out-of-date CQI report is used as input parameter for the link adaptation entity. The channel quality feedback cycle (k-factor), which determines the frequency for sending channel quality reports to the serving Node B, can take on several predefined values in the range between 1 and 80 (and also the value 0, but then the reporting is completely switched off) and it is signalled to both the Node-Bs and the terminals by means of higher layers. However, this implies that especially for rather high values of the k-factor, the actual current channel quality at the scheduling instant might significantly deviate from the channel quality reported to the Node B in the last CQI report. Consequently—in case such out-of-date reports are used—the probability for a successful transmission decreases, therefore leading to a decrease in the cell capacity and the overall system performance in general.

The outer loop link adaptation tries to compensate for this increased frame error probability by increasing the CQI offset, but this implies that for all received CQI values this increased offset is used, i.e. also in case that the CQI report of the scheduled user is rather new and therefore reflects the current channel conditions rather adequately. For that reason, the cell capacity is even further decreased, as in some cases—especially if a relatively new CQI report is available—resources might be wasted by choosing a stronger modulation and coding scheme (MCS) than actually really necessary.

In addition, in such a system users are not necessarily scheduled “on top of their fades” anymore in case that a P-FR scheduler is used. For example if the scheduler assumes a user to be “on top of a fade” according to the last received CQI report, this might not actually be the case due to the out-dated nature of this report. In the worst case, this user could be even in a deep fade at the scheduling instant. Consequently, this can be considered as scheduling error.

So in general the performance should be always better for smaller k-factors. However, small k-factors, i.e. frequent transmissions of channel quality reports to the Node-B, come at the expense of an increased uplink interference level, which has a negative impact on the overall uplink performance. At the same time, the terminals have to measure the current channel quality relatively often, resulting in higher power consumption and consequently shorter operating times of the terminals. In addition, the Node-Bs have to receive and to process all CQI reports, which requires higher computational effort. Consequently, there are several issues which make the usage of relatively long channel quality feedback cycles (i.e. large k-factors) favourable.

Therefore, the goal is to minimize the performance loss for long channel quality feedback cycles compared to the situation where the current channel quality is reported in every TTI to the serving Node-B, thus being able to significantly reduce the uplink interference level and to extend the operating times of the terminals.

One approach for dealing with the mentioned problem is described in: “A variable rate channel quality feedback scheme for 3G wireless packet data systems”, A. Das, F. Khan, A. Sampath and H. Su, Proceedings of the IEEE International Conference on Communications (ICC), May 2003, pp. 982-986. In this approach, a variable rate channel quality feedback scheme is proposed, which exploits the bursty nature of data traffic by sending frequent CQI reports when a data transmission takes place and only infrequent CQI reports during periods of inactivity. In this way, the performance can be significantly improved while keeping the uplink interference level relatively low. However, the solution is not in line with the current specifications, as the k-factor is not kept constant, but rather dynamically adjusted by the terminals. In addition to that, there is only a significant gain in case that the data traffic is very bursty, as in the case of web-browsing, for example, but not for streaming services or similar constant data-rate applications.

There is therefore a need for a means of improving performance, especially in the situation where constant k-factors are used.

According to one aspect of the present invention there is provided a method for selecting a communication parameter to be used in a communication system based on inputs including an estimate of communication quality between a first node and a second node, the method comprising selecting the parameter based on the estimate of communication quality and also the age of the estimate of communication quality.

Preferably the estimate of communication quality is an estimate of communication quality between a first node and a second node, and the method comprises the step of communicating between the first node and the second node using the selected parameter.

Preferably one of the nodes is a mobile station. Preferably one of the nodes is a Node B.

Preferably the parameter is a modulation and/or coding scheme and/or power setting. Alternatively, the parameter could be a scheduling time for communications.

Preferably the step of selecting the parameter is performed by an entity of the communication system and the age of the estimate of communication quality is the time since the estimate was received by that entity.

Preferably the entity is a packet data access node of the communication system.

Preferably the step of selecting the parameter based on the estimate of communication quality and also the age of the estimate of communication quality has the effect of applying an offset to the estimate, the size of the offset being dependent on the age of the estimate.

Preferably the size of the estimate is also dependent on the magnitude of the estimate of communication quality.

Preferably for constant age of the estimate the offset is larger for larger estimates.

Preferably the offset is such as to reduce the effective estimated quality.

Preferably the offset increases with increasing age of the estimate, and the extent to which the offset increases with increasing age of the estimate decreases with increasing age of the estimate.

Preferably a plurality of nodes of the system communicate with another node of the system, estimates of communication quality for communications between each of the plurality of nodes and the other node are processed as claimed in any preceding claim, and the system is arranged so that estimates of communication quality for each of those communications are formed with equal frequency.

Preferably a plurality of nodes of the system communicate with another node of the system, estimates of communication quality for communications between each of the plurality of nodes and the other node are processed as claimed in any preceding claim, and the system is arranged so that estimates of communication quality for each of those communications are formed with at moment uniformly distributed over time.

Preferably the system is a High Speed Downlink Packet Access system.

According to a second aspect of the invention there is provided a processing arrangement configured for selecting a communication parameter to be used in a communication system based on inputs including an estimate of communication quality between a first node and a second node, the arrangement being configured to select the parameter based on the estimate of communication quality and also the age of the estimate of communication quality.

Preferably, the processing arrangement comprises a processor and a program store for storing instructions. Additionally, the processing arrangement is arranged to execute instructions stored in the program store.

According to a third aspect of the invention there is provided a mobile station comprising a processing arrangement configured for selecting a communication parameter to be used in a communication system based on inputs including an estimate of communication quality between a first node and a second node, the arrangement being configured to select the parameter based on the estimate of communication quality and also an age of the estimate of communication quality.

According to a fourth aspect of the invention there is provided a Node B comprising a processing arrangement configured for selecting a communication parameter to be used in a communication system based on inputs including an estimate of communication quality between a first node and a second node, the arrangement being configured to select the parameter based on the estimate of communication quality and also an age of the estimate of communication quality.

According to a fifth aspect of the invention there is provided a network entity arranged to select a communication parameter to be used in a communication system based on inputs including an estimate of communication quality between a first node and a second node, the network entity comprising means to select the parameter based on the estimate of communication quality and also an age of the estimate of communication quality.

The present invention will now be described by way of example with reference to the accompanying drawings.

In the drawings:

FIG. 1 illustrates the formula for calculating the newly introduced offset Offset_{age} used for the first implementation approach.

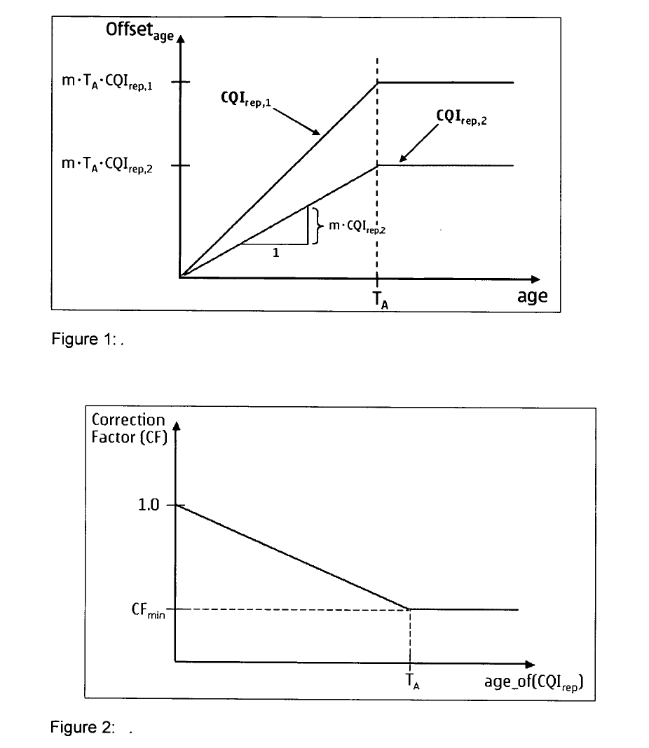

FIG. 2 illustrates the formula used for calculating the correction factor for adjusting the scheduling metric introduced in conjunction with the second implementation approach.

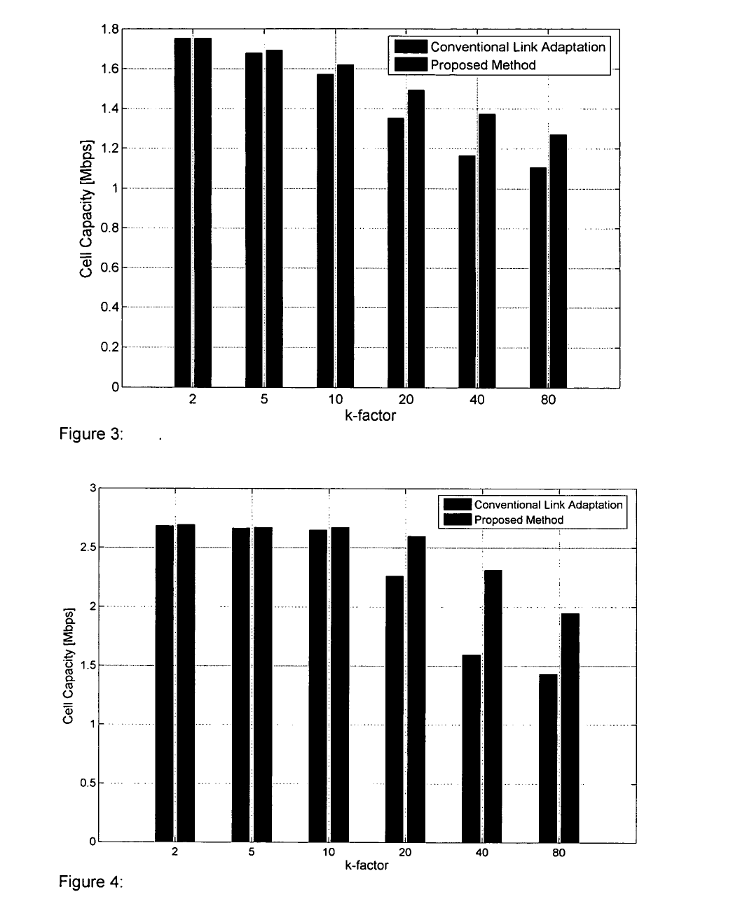

FIG. 3 illustrates a comparison of the system performance in terms of the cell capacity between the new method (according to the first proposed implementation approach) and the conventional link adaptation method which does not consider the age of CQI reports. Results were obtained from a dynamic system-level simulator for a ITU Vehicular-A macro cell scenario with an average number of 30 users per cell, with the parameters (discussed in more detail below) set to T_{A}=20 TTI and m=0.01/TTI. The underlying traffic model is a full buffer model and otherwise generally standard parameter settings were used.

FIG. 4 depicts the same information as FIG. 3, but the simulations were performed for a ITU Pedestrian-A power delay profile. The average number of users per cell was also set to 30 and T_{A} as well as m have the same values as in the previous case.

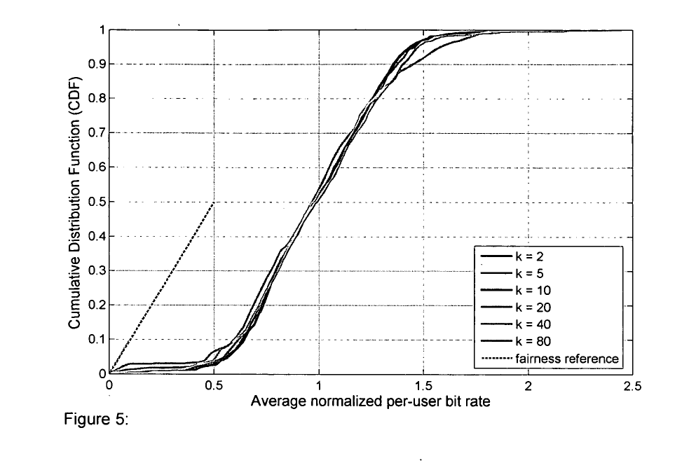

FIG. 5 shows the cumulative distribution functions (CDF) of the average normalized per-user bit rates for the modified link adaptation mechanism according to the first implementation approach for different k-factors as well as the fairness reference curve according to “1xEV-DV Evaluation Methodology (V10)”, 3GPP2 Technical Specification TSG-C.R1002, 2003. The average number of users per cell is 10, T_{A}=20 TTI and m=0.01/TTI. It can be seen that fairness among the different users is achieved since all CDFs lie to the right of the fairness reference curve.

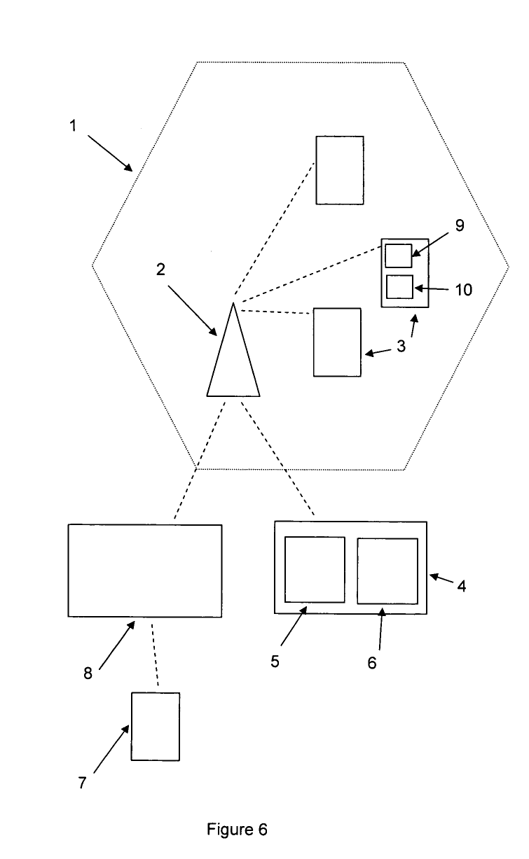

FIG. 6 illustrates the architecture of a system suitable for implementing the present invention.

The basic idea behind embodiments of the present invention is for the link adaptation process to be dependent on the content of a CQI (or like) report and also on the age of the report. The aim of this is to improve the system performance, especially for large channel quality feedback cycles (k-factors).

As newer CQI reports generally reflect the current channel conditions more reliably than old ones, according to this scheme priority should be increased for users for whom a new CQI report is available. At the same time, the actual selection of an appropriate MCS could also be influenced by the age of the corresponding CQI report, i.e. if the CQI report of a scheduled user is relatively old, a stronger MCS could be chosen than actually requested by the terminal. This way, the aforementioned disadvantages of using large k-factors can be significantly reduced while the advantages remain the same.

In one exemplary embodiment the present invention can be applied to the HSDPA link adaptation entities in Node-Bs. In this environment it can be readily implemented and does not require any modifications to the existing 3GPP (release 5) specifications.

The following description presents two detailed ways for implementing the invention. The first approach is to introduce an additional CQI offset in the Node-B. The second one is to directly adjust the priority metrics of the P-FR scheduler. The invention could be implemented in other ways too.

1) Introduction of an Additional CQI Offset

For improving the performance for large values of the k-factor, an additional offset can be introduced and subtracted from the CQI value reported to the Node-B before determining the corresponding modulation and coding scheme that might be used for a transmission to the respective terminal in the next TTI. The size of this offset is determined in dependence on the age of the CQI report: preferably for old CQI reports generally a larger offset is used than for relatively new ones. The size of the new offset preferably also depends on the size of the reported CQI value, i.e. if a very high value has been reported, the offset should also be very high, because in such a case the probability that the current channel conditions are much worse during the actual data transmission is higher than in the case where a rather low CQI value has been reported. In a preferred embodiment the actual CQI value that serves as the basis for the MCS selection can be calculated as follows:
CQI_{eff}=└CQIᵣₑₚ−Offset_{age}−Offset_{outer loop LA}┘
with
Offset_{age}=f(CQIᵣₑₚ,age_of(CQIᵣₑₚ)),
where CQIᵣₑₚ is the reported CQI value, Offset_{outer loop LA} the offset introduced by the outer loop link adaptation and Offset_{age} our newly introduced offset, which is a function of both the age of the last CQI report as well as the actual CQI value itself. The “age” of a CQI report may be judged in a number of ways, but it could conveniently be chosen to be equal to the time that has passed since the corresponding CQI report was received by the Node-B. As an example, it could also be based on the time since the measurement was made, if that data is included in the report. Note, that both the newly introduced offset Offset_{age} as well as the offset Offset_{outer loop LA} introduced by the outer loop link adaptation are generally rational numbers. Therefore, the floor function (└·┘-operator) is employed in the equation given above in order to obtain a valid (integer) CQI value. Rounding the calculated value is an alternative to using the floor function, but taking the floor is generally preferable because otherwise possibly larger CQI indices would be used than are really supported by the current channel conditions. The formula used for the conventional link adaptation mechanism is exactly the same as the formula given above, but with Offset_{age} set to zero.

By making use of this modified link adaptation mechanism, the performance can be improved in two different ways. On the one hand, the probability increases that users for whom a relatively new CQI report is available are scheduled (at least in case that a P-FR scheduler is used), because the currently achievable bit rate—which is contained in the formula for calculating the scheduling metric of the P-FR scheduler—is directly related to the chosen MCS and hence the offset-compensated CQI value. As new CQI reports are generally more reliable than old ones, this will be expected to have a positive impact on the frame error probability and increase the probability that users are really scheduled “on top of their fades” at the same time. On the other hand, the offset introduced by the outer loop link adaptation will be decreased, as the originally received CQI index is already reduced by the new offset. This is advantageous, because the offset of the outer loop link adaptation is subtracted from the base CQI value, independent of the age of the last CQI report. So also if the CQI report is very new and consequently reflects the current channel conditions quite well, a stronger MCS is chosen than actually really needed. With the mechanism described herein, the overall offset depends on the age of the CQI report and therefore is more suitable to adapt to the real channel conditions in a flexible way.

A significant point of this approach is obviously how the new offset should be chosen in dependence of the age and CQI value of the last received channel quality report. This can be done in a number of ways. One possible solution—which will be described in more detail below—is to use a linear relationship between the age of a CQI report and the offset, for in case that the CQI value itself is the same. However, as the reliability of a CQI report does not significantly change if the report is already rather old, (that age being related to the coherence time in the system), the offset can advantageously be made constant thereafter. The time when this shift from a linear relationship to a constant value takes place will be designated as T_{A} in the following, whereas the slope of the linear relationship is denoted by m·CQIᵣₑₚ. The actual value of the offset then can be calculated as follows:

$${Offset}_{age} = \{ \begin{matrix}age\_of ( {CQI}_{rep} ) \cdot m \cdot {CQI}_{rep} & for age\_of ( {CQI}_{rep} ) < {T}_{A} \\ {T}_{A} \cdot m \cdot {CQI}_{rep} & for age\_of ( {CQI}_{rep} ) \geq {T}_{A}\end{matrix}$$

An illustration of this equation is given in FIG. 1 for two different CQI values CQI_{rep,1} and CQI_{rep,2}. m and TA should preferably be chosen such that the following statement is always fulfilled:
0≦m·T_{A}≦1

Otherwise, old CQI reports would be either graded up, hence leading to an even worse system performance (in the case that m·T_{A}<0), or the age offset might be bigger than the actually reported CQI value (in the case that m·T_{A}>1).

Empirically, the inventors have determined that m=0.01/TTI and T_{A}=20 TTI yield good results in the case where users are moving at a speed of the order of 3 km/h. Simulation results for this case are given in FIGS. 3 to 5.

In order to get a high improvement and to be able to provide fairness among different users, all users in one cell should preferably use the same k-factor. Otherwise, users with a smaller k-factor would be relatively prioritized. However, having all users in one cell use the same k-factor does not generally represent any problem, as the k-factor is a parameter which is signalled to the terminals and the Node-B by means of higher layers and consequently can be configured by the network operator, see also 3GPP Technical Specification 25.214, “Physical Layer Procedures (FDD)”, version 5.9.0, June 2004 and 3GPP Technical Specification 25.331, “Radio Resource Control (RRC) Protocol Specification”, version 5.10.0, September 2004.

In addition, instants at which the various terminals served by a Node-B provide their channel quality feedback reports should preferably be uniformly distributed, so that at every scheduling instant the distribution of the ages of the different CQI reports also follows a uniform distribution. If this was not done, in the worst case all terminals might report their current channel quality in the same TTI, which would lead to a significant reduction of the gain that can be obtained by applying this method. However, even in this case with an appropriate selection of the parameters m and T_{A} the performance should still be better than the performance of the conventional link adaptation mechanism, because the age of the CQI reports is taken into account for selecting a suitable modulation and coding scheme. Anyway, generally the assumption of a uniform distribution of the reporting instants is fulfilled, as users usually start new sessions independently from each other.

The additional complexity for implementing the proposed method is marginal, as only a timestamp has to be stored for every received CQI report and the new offset has to be calculated and subtracted from the received CQI value at every scheduling instant. Hence, the required memory and additional computational complexity are both relatively small, especially compared to the gain that can be achieved by applying this method.

2) Direct Adjustment of the Scheduling Priority Metric

Another approach is to directly adjust the scheduling priority metric, dependent on the age of the last received CQI report. The formula for calculating the scheduling metrics for the P-FR scheduler, as presented above, can be modified as follows:

$$\begin{matrix}{M}_{k} [ n ] = {CF}_{k} [ n , u , KF ] \cdot \frac{{R}_{k} [ n ]}{{T}_{k} [ n ]} \\ = {CF}_{k} [ n , u , KF ] \cdot \frac{{R}_{ k} [ n ]}{\begin{matrix}( 1 - \{ \{ {B}_{ k} [ n ] > 0 \} ⋁ \{ {R}_{ k} [ n - 1 ] > 0 \} \} \cdot \\ {FF}_{ k} ) \cdot {T}_{ k} [ n - 1 ] + {FF}_{ k} \cdot {R}_{ k} [ n - 1 ]\end{matrix}}\end{matrix}$$

As can be seen, an additional correction factor CFₖ[n,u,KF] has been introduced, which generally is a function of the time that has passed since the last channel quality report has been received, the value of the k-factor KF as well as the number of users u currently served by the respective Node-B.

The basic idea is to choose a correction factor in the range between 0.0 and 1.0. The older a CQI report serving as the basis for the calculation of the scheduling metric is, the smaller the correction factor should be chosen, thus decreasing the probability that the corresponding user is scheduled. Assuming that all users served by the same Node B use the same k-factor, this modification to the calculation of the scheduling metric should also not have any significant influence on the user fairness, because all users are treated in the same way.

Of course, there are many different possibilities for calculating such a correction factor and different situations might require different factors. One possibility is given by the following formula:

$$CF = max \{ 1 - \frac{1 - {CF}_{min}}{{T}_{A}} \cdot age\_of ( {CQI}_{rep} ) , {CF}_{min} \}$$

Here, CFₘᵢₙ denotes the minimum value that may be used for the correction factor, age_of(CQIᵣₑₚ) the age of the respective channel quality report (i.e. the time that has passed since the report has been received) and T_{A} some “threshold” age again, after which the correction factor remains constant—similar to the corresponding parameter mentioned in the first approach. The parameters CFₘᵢₙ and T_{A} can be chosen to adjust the correction factor according to the respective needs. Influencing factors for choosing these parameters could be the current number of active users or the value of the k-factor, for example.

The techniques described above provide a way in which system performance, e.g. in a HSDPA system) can be significantly improved, especially for large k-factors (i.e. long channel quality feedback cycles). This holds in particular for the total cell capacity as well as the average per-user bit rates.

Thus the disadvantages of using long channel quality feedback cycles can be significantly reduced while the advantages remain the same. Using larger k-factors is generally beneficial, because:

a. in such a case, the terminals don't have to measure the current channel quality all the time, what leads to less power consumption and hence longer operating times.

b. if fewer CQI reports are sent, the uplink interference can be reduced, having a positive effect on the overall system performance

c. the computational effort in the Node-Bs can be reduced

Assuming reasonable parameter settings, the performance of the proposed method is never worse than the performance of the conventional link adaptation mechanism and the additional complexity is rather small.

FIG. 6 illustrates an example of a system in which the present invention can be implemented. A communication cell 1 is defined in the vicinity of a base station transceiver (BTS) 2. Mobile user equipment (UE) stations 3 can communicate wirelessly by radio with the BTS 2. Node B processing equipment 4 comprising a central processor 5 and a program store 6 is connected to the BTS for providing HSDPA Node B facilities to the UEs. The UEs can communicate with other entities 7 via a network 8. The central processor 5 of the Node B equipment 4 is arranged to execute program code stored in the program store 6 so as to provide the Node B facilities. This includes instructions to process measurement reports as described above. Each UE may have a processor 9 and a program store 10 that can include instructions to form and transmit measurement reports as described above. The measurement reports could be formed at the network end. The measurement reports could be processed at the mobile end.

The present invention is applicable to systems other than the HSDPA system.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

Abbreviations:
3GPP Third Generation Partnership Project
BTS Base Transceiver Station
CDF Cumulative Distribution Function
CF Correction Factor
CQI Channel Quality Indicator
FDD Frequency Division Duplex
FF Forgetting Factor
HSDPA High Speed Downlink Packet Access
KF k-Factor
MCS Modulation and Coding Scheme
P-FR Proportional Fair
TTI Transmission Time Interval
UE User Equipment

1. A method for selecting a communication parameter to be used in a communication system based on inputs including an estimate of communication quality between a first node and a second node, the method comprising selecting the parameter based on the estimate of communication quality and an age of the estimate of communication quality.

2. A method as claimed in claim 1, wherein the estimate of communication quality is an estimate of communication quality between a first node and a second node, and the method comprises the step of communicating between the first node and the second node using the selected parameter.

3. A method as claimed in claim 1, wherein one of the nodes is a mobile station.

4. A method as claimed in claim 1, wherein one of the nodes is a Node B.

5. A method as claimed in claim 1, wherein the parameter is at least one of a modulation, coding scheme, and power setting.

6. A method as claimed in claim 1, wherein the parameter is a scheduling time for communications.

7. A method as claimed in claim 1, wherein the step of selecting the parameter is performed by an entity of the communication system and the age of the estimate of communication quality is the time since the estimate was received by that entity.

8. A method as claimed in claim 7, wherein the entity is a packet data access node of the communication system.

9. A method as claimed in claim 1, wherein the step of selecting the parameter based on the estimate of communication quality and also the age of the estimate of communication quality has the effect of applying an offset to the estimate, the size of the offset being dependent on the age of the estimate.

10. A method as claimed in claim 9, wherein the size of the estimate is also dependent on a magnitude of the estimate of communication quality.

11. A method as claimed in claim 10, wherein for a constant age of the estimate the offset is larger for larger estimates.

12. A method as claimed in claim 9, wherein the offset is such as to reduce an effective estimated quality.

13. A method as claimed in claim 9, wherein the offset increases with increasing age of the estimate, and an extent to which the offset increases with increasing age of the estimate decreases with the increasing age of the estimate.

14. A method as claimed in claim 1, wherein a plurality of nodes of the system communicate with another node of the system, estimates of communication quality for communications between each of the plurality of nodes and the other node are processed for the plurality of nodes and the other node and the system is arranged so that estimates of communication quality for each of those communications are formed with equal frequency.

15. A method as claimed in claim 1, wherein a plurality of nodes of the system communicate with another node of the system, estimates of communication quality for communications between each of the plurality of nodes and the other node are processed for the plurality of nodes and the other node and the system is arranged so that estimates of communication quality for each of those communications are formed at moments uniformly distributed over time.

16. A method as claimed in claim 1, wherein the system is a High Speed Downlink Packet Access system.

17. A processing arrangement configured for selecting a communication parameter to be used in a communication system based on inputs including an estimate of communication quality between a first node and a second node, the arrangement being configured to select the parameter based on the estimate of communication quality and also an age of the estimate of communication quality.

18. A processing arrangement as claimed in claim 17, wherein the processing arrangement comprises a processor and a program store for storing instructions.

19. A processing arrangement as claimed in claim 18, wherein the processor is arranged to execute instructions stored in the program store.

20. A mobile station comprising a processing arrangement configured for selecting a communication parameter to be used in a communication system based on inputs including an estimate of communication quality between a first node and a second node, the arrangement being configured to select the parameter based on the estimate of communication quality and also an age of the estimate of communication quality.

21. A Node B comprising a processing arrangement configured for selecting a communication parameter to be used in a communication system based on inputs including an estimate of communication quality between a first node and a second node, the arrangement being configured to select the parameter based on the estimate of communication quality and also an age of the estimate of communication quality.

22. A network entity arranged to select a communication parameter to be used in a communication system based on inputs including an estimate of communication quality between a first node and a second node, the network entity comprising means to select the parameter based on the estimate of communication quality and also an age of the estimate of communication quality.
